(19) United States
(12) Patent Application Publication
(10) Pub. No.: US 2020/0039335 A1
(43) Pub. Date: Feb. 6, 2020

(54) OPENING AND CLOSING STRUCTURE FOR A VEHICLE

(71) Applicant: KABUSHIKI KAISHA TOYOTA JIDOSHOKKI, Aichi-ken (JP)

(72) Inventors: Taishi MOCHIZUKI, Aichi-ken (JP); Hirotaka INABA, Aichi-ken (JP)

(73) Assignee: KABUSHIKI KAISHA TOYOTA JIDOSHOKKI, Aichi-ken (JP)

(21) Appl. No.: 16/524,555

(22) Filed: Jul. 29, 2019

(30) Foreign Application Priority Data
Aug. 2, 2018 (JP) 2018-145966

(51) Int. Cl. B60J 5/12; E05D 1/00

(52) U.S. Cl. CPC B60J 5/12; E05Y 2900/546; E05D 1/00

(57) ABSTRACT

An opening and closing structure for a vehicle includes a pair of guide rails and an opening and closing unit. The opening and closing unit includes a plurality of slats, a reinforcement, a first joint portion, and second joint portions. The plurality of slats are made of resin and arranged side by side in an extending direction of the guide rails. The reinforcement reinforces two of the slats that are adjacent to each other. The first joint portion is made of a flexible material which is more flexible than the resin forming the slats. The first joint portion joins the two adjacent slats. The second joint portions each join the two adjacent slats to the reinforcement. The reinforcement is configured to cover the second joint portions.

### CROSS-REFERENCE TO RELATED APPLICATION

This application claims priority to Japanese Patent Application No. 2018-145966 filed on Aug. 2, 2018, the entire disclosure of which is incorporated herein by reference.

### BACKGROUND ART

The present disclosure relates to an opening and closing structure for a vehicle.

Japanese Utility Model Application Publication No. 61-113122 discloses a conventional opening and closing structure for a vehicle. The opening and closing structure for the vehicle in the Publication includes a rear gate frame serving as a peripheral edge portion of a rear gate, a roller shutter slidably guided along the rear gate frame, and a roller rolling up the shutter. The shutter has a structure in which multiple slats are stacked in the vertical direction and connected. The opposite ends of each slat in the longitudinal direction thereof are guided along side parts of the rear gate frame.

However, according to the opening and closing structure for the vehicle in the Publication, there are the following problems. Considering an airtightness of the shutter, any two adjacent slats need to be jointed with a flexible material such as an elastomer. In this case, the flexible materials joining the slats may be cut from the outside of the vehicle, and then belongings left in the vehicle may be stolen.

The present disclosure has been made in view of the above circumstances and is directed to providing an opening and closing structure for a vehicle preventing access into the vehicle while ensuring an airtightness.

### SUMMARY

In accordance with an aspect of the present disclosure, there is provided an opening and closing structure for a vehicle that includes a pair of guide rails disposed to extend facing each other across an opening formed in the vehicle and an opening and closing unit slidably guided along the pair of guide rails and configured to open and close the opening. The opening and closing unit includes a plurality of slats, a reinforcement, a first joint portion, and second joint portions. The plurality of slats are made of resin and arranged side by side in an extending direction of the guide rails. The reinforcement reinforces two of the slats that are adjacent to each other. The reinforcement is disposed to extend in a direction perpendicular to the extending direction of the pair of guide rails. The first joint portion is made of a flexible material which is more flexible than the resin forming the slats. The first joint portion joins the two adjacent slats. The second joint portions each join the two adjacent slats to the reinforcement. The reinforcement is configured to cover the second joint portions.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a perspective view of a rear side of a vehicle including an opening and closing structure for the vehicle according to an embodiment of the present disclosure;

FIG. 2 is a perspective view of the rear side of the vehicle of FIG. 1, showing a back door of the vehicle in an open state;

FIGS. 3A and 3B are partially enlarged cross-sectional views of the back door illustrated in FIG. 1; and

FIG. 4 is a cross-sectional view of the back door illustrated in FIG. 1 and elevating guide rails.

### DETAILED DESCRIPTION OF THE EMBODIMENTS

The following will describe an embodiment of the present disclosure in detail with reference to the accompanying drawings.

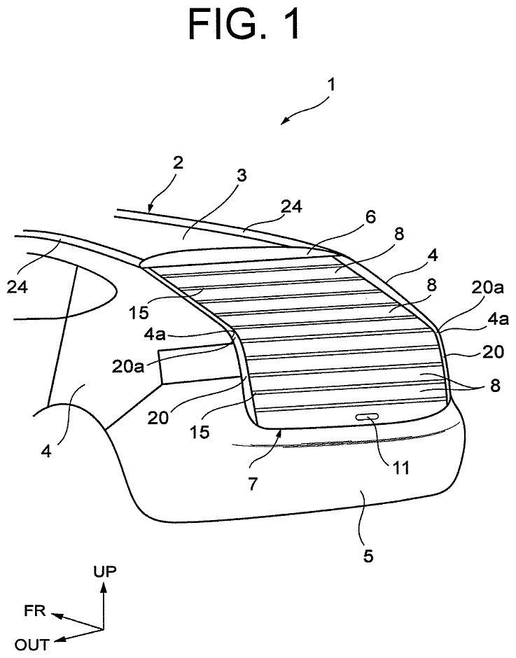

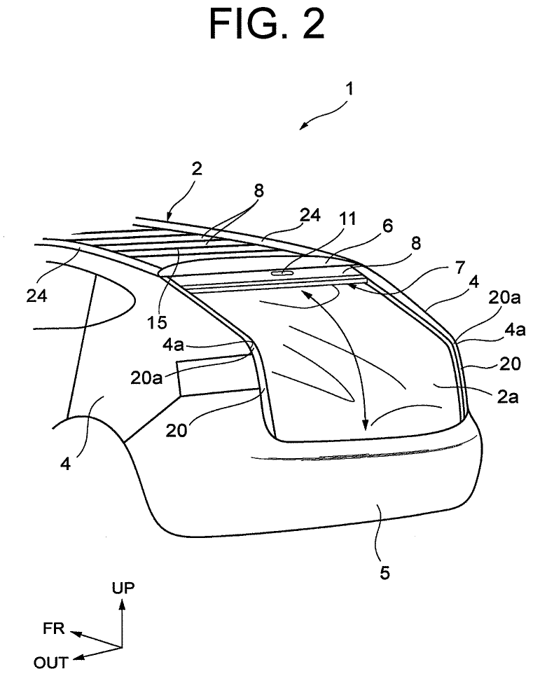

FIG. 1 is a perspective view of the rear side of a vehicle including an opening and closing structure for the vehicle according to an embodiment of the present disclosure. In FIG. 1, a vehicle 1 includes a vehicle body 2. Arrows FR, UP, and OUT in FIGS. 1 and 2 indicate the front side in the longitudinal direction of the vehicle body 2, the upper side in the vertical direction of the vehicle body 2, and the outside, that is, the left side in the short direction (in the width direction) of the vehicle body 2, respectively.

The vehicle body 2 has a roof panel 3 and a pair of side panels 4 disposed on opposite sides of the roof panel 3 in the width direction of the vehicle body 2. The roof panel 3 is disposed in the upper part of the vehicle body 2. The side panels 4 are disposed in the opposite side parts of the vehicle body 2. A bumper 5 is disposed in the lower part of the rear end of the vehicle body 2. A spoiler 6 is disposed in the upper part of the rear end of the vehicle body 2.

As illustrated in FIG. 2, the vehicle body 2 has in the rear end part thereof an opening 2a. The opening 2a is defined by the rear end of the roof panel 3, the rear ends of the pair of side panels 4, and the upper end of the bumper 5. Each side panel 4 has in the rear end thereof a curved portion 4a. The opening 2a has a curved shape curved toward the front side of the vehicle body 2 in the upper area above the curved portion 4a of the opening 2a (hereinafter simply called the upper area of the opening 2a).

The vehicle 1 includes an opening and closing type back door 7 covering the opening 2a of the rear end part of the vehicle body 2. The back door 7 corresponding to an opening and closing unit of the present disclosure is configured to move elevatably relative to the opening 2a to open and close the opening 2a. FIGS. 1 and 2 show the vehicle 1 in a closed state and an opened state of the back door 7, respectively. In the following description, the vertical direction in which the back door 7 moves is defined in the closed state of the back door 7 (see FIG. 1).

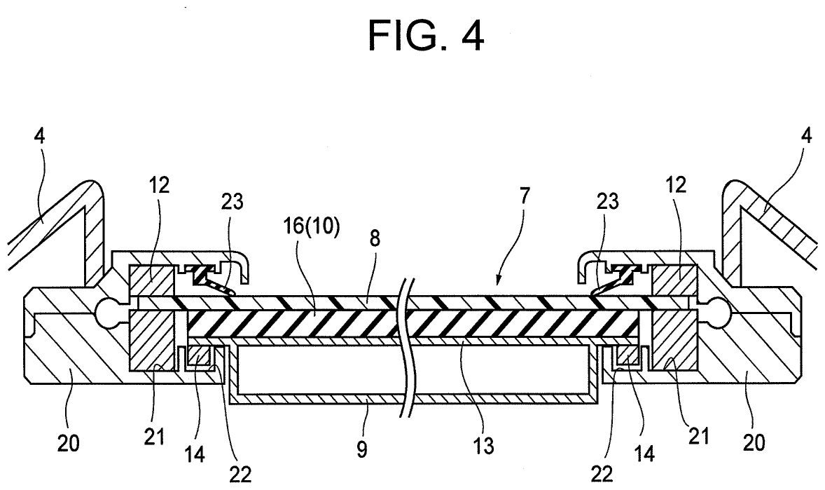

As illustrated in FIGS. 1, 3A, 3B, and 4, the back door 7 includes a plurality of slats 8, a plurality of reinforcements 9, and a plurality of joint members 10. The slats 8 are arranged side by side in the vertical direction of the vehicle body 2. Each reinforcement 9 of the present disclosure reinforces two adjacent slats 8 and is disposed so as to extend in the width direction of the vehicle body 2. Each joint member 10 joins the two adjacent slats 8 to the reinforcement 9 as well as joins the two adjacent slats 8 to each other.

Each slat 8 extends in the width direction of the vehicle body 2. The undermost slat 8 in the vertical direction of the vehicle body 2 has a door pull 11 for an opening and closing operation of the back door 7. Sliding shoes 12 are attached to the opposite ends of each slat 8 in the width direction of the vehicle body 2. The slats 8 are made of transparent resin having shock resistance, such as polycarbonate resin and acrylic resin.

Each reinforcement 9 is disposed in an area containing a joint between two adjacent slats 8 and located inward of the slats 8 (inside the vehicle 1). This means that the reinforcement 9 is disposed so as to cover the joint member 10. The reinforcement 9 has a rectangular tube shape. The opposite ends of the reinforcement 9 are located inward of the opposite ends of the slat 8 in the width direction of the vehicle body 2. The reinforcement 9 has a jointed tabular portion 13 facing the two adjacent slats 8. Positioning protrusions 14 are disposed in the opposite ends of the jointed tabular portion 13.

The reinforcements 9 are made of a hard material, such as carbon fiber reinforced plastics (CFRP), aluminum, and iron. Each reinforcement 9 ensures the stiffness of the two adjacent slats 8 connected thereto. The reinforcements 9 may be disposed between two adjacent slats 8 located between the lower end and the upper end of the back door 7, that is, in the overall back door 7 in the vertical direction of the vehicle body 2, or only in part (e.g., the lower part) of the back door 7.

The joint members 10 are made of a flexible material which is more flexible than the transparent resin forming the slats 8. Such a flexible material includes an elastomer and the like. Each joint member 10 is configured of the first joint portion 15 joining two adjacent slats 8, and a pair of the second joint portions 16 joining the two adjacent slats 8 to the reinforcement 9. Thus, the first joint portion 15 and the second joint portions 16 integrally form the joint member 10.

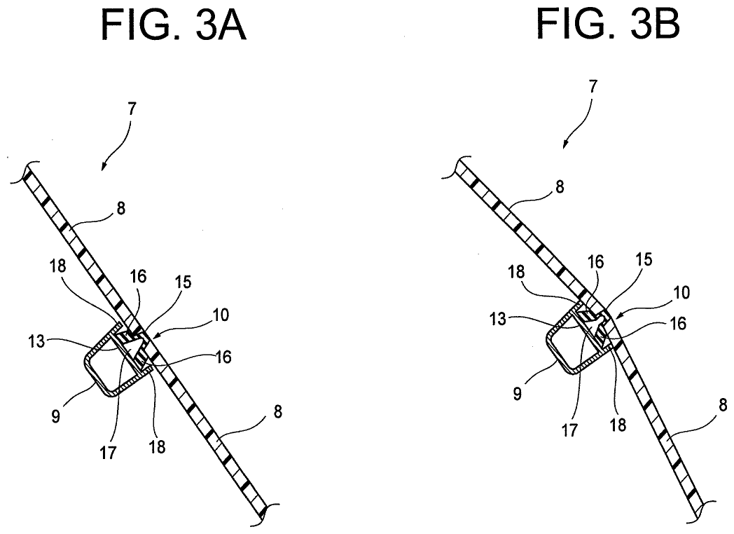

Each first joint portion 15 is disposed between two adjacent slats 8. This means that each slat 8 and the first joint portion 15 are alternatively arranged in the vertical direction of the vehicle body 2. As illustrated in FIGS. 3A and 3B, each second joint portion 16 is disposed between two adjacent slats 8 and the jointed tabular portion 13 of the reinforcement 9. This means that the second joint portions 16 are disposed inward of the slats 8. The second joint portions 16 have therebetween a void 17 extending through the flexible material. In other words, the second joint portions 16 define the void 17.

The first joint portion 15 and the second joint portions 16 extend in the width direction of the vehicle body 2. The second joint portions 16 need not extend in the width direction of the vehicle body 2, and may be disposed intermittently in the width direction of the vehicle body 2. The first joint portion 15 and the second joint portions 16 are covered with the reinforcement 9.

Each reinforcement 9 has two protrusions 18 protruding toward the slats 8 from the opposite ends of the jointed tabular portion 13 in the vertical direction of the vehicle body 2 to conceal the second joint portions 16. The protrusions 18 are disposed to extend in the width direction of the vehicle body 2 and face each other across the second joint portions 16. As illustrated in FIG. 3A, in a state in which the two adjacent slats 8 extend linearly, a predetermined space is provided between ends of the protrusions 18 and the slats 8. As illustrated in FIG. 3B, this space permits the two adjacent slats 8 to be bent at the first joint portion 15, which will be described in detail later.

Each side panel 4 has in the rear end part thereof an elevating guide rail 20. The back door 7 is slidably guided along a pair of the elevating guide rails 20 in the vertical direction of the vehicle body 2. The elevating guide rails 20 correspond to the guide rails of the present disclosure. This means that the vehicle 1 includes the pair of elevating guide rails 20 disposed to extend in the vertical direction of the vehicle body 2 and face each other across the opening 2a formed in the rear end part of the vehicle body 2 of the vehicle 1.

As described above, each side panel 4 has in the rear end thereof the curved portion 4a, and the upper area of the opening 2a has a curved shape curved toward the front side of the vehicle body 2. With this configuration, each elevating guide rail 20 also has a curved portion 20a curved along the curved portion 4a of the side panel 4 in the extending direction of the elevating guide rail 20. The upper part of the elevating guide rail 20 has a curved shape curved toward the front side of the vehicle body 2 along the shape of the opening 2a.

In the back door 7 described above, the plurality of slats 8 made of resin are arranged side by side in the extending direction of the elevating guide rails 20. The reinforcements 9 are disposed to extend in a direction perpendicular to the extending direction of the pair of elevating guide rails 20.

Each elevating guide rail 20 has a shoe accommodating portion 21 engaged with the sliding shoe 12 of the back door 7 and a protrusion accommodating portion 22 engaged with the positioning protrusion 14 of the back door 7. The protrusion accommodating portion 22 is disposed inward of the shoe accommodating portion 21 in the width direction of the vehicle body 2. The elevating guide rail 20 also has a side seal 23 to seal the back door 7. The side seal 23 is disposed inward of the shoe accommodating portion 21 in the width direction of the vehicle body 2 and faces the protrusion accommodating portion 22 across the back door 7.

When the back door 7 performs the opening and closing motion along the elevating guide rails 20, the sliding shoes 12 slide in the shoe accommodating portions 21 with the positioning protrusion 14 positioned in the protrusion accommodating portion 22.

The roof panel 3 has on the upper surface thereof roof guide rails 24 in the opposite ends in the width direction of the vehicle body 2. The roof guide rails 24 slidably guide the back door 7 in the longitudinal direction of the vehicle body 2. In other words, the vehicle 1 includes a pair of the roof guide rails 24 disposed so as to extend in the longitudinal direction of the vehicle body 2. Each roof guide rail 24 may be disposed continuously to each elevating guide rail 20, or at a short distance from the elevating guide rail 20. The structure of the roof guide rail 24 is not described here.

In the opening and closing structure for the vehicle 1 described above, as illustrated in FIG. 1, the back door 7 is locked by a locking mechanism (not illustrated), when the back door 7 is in a completely closed state. After unlocking the back door 7 in the completely closed state, an operator moves up the back door 7 with the door pull 11. At this time, the back door 7 moves toward the upper side of the vehicle body 2 along the elevating guide rails 20, while moving toward the front side of the vehicle body 2 along the roof guide rails 24, so that the back door 7 is opened as illustrated in FIG. 2. Once the back door 7 is in the opened state, the back door 7 keeps the opened state by sliding resistance between the sliding shoes 12 and the elevating guide rails 20.

In the opened state of the back door 7, the operator moves down the back door 7 with the door pull 11. At this time, the back door 7 moves toward the lower side of the vehicle body 2 along the elevating guide rails 20 while moving toward the rear side of the vehicle body 2 along the roof guide rails 24, so that the back door 7 is closed.

In performing the opening and closing motion of the back door 7, the adjacent slats 8 except the slats 8 located in the vicinity of the curved portion 20a of each elevating guide rail 20 extend linearly along the elevating guide rail 20 as illustrated in FIG. 3A and the linear state is maintained. The adjacent slats 8 located in the vicinity of the curved portion 20a of the elevating guide rail 20 are bent at the first joint portion 15 as illustrated in FIG. 3B, due to elastic deformation of the first joint portion 15 following the shape of the curved portion 20a.

In the present embodiment described above, the back door 7 includes the first joint portion 15 made of a flexible material which is more flexible than the transparent resin forming the slats 8 and joining two adjacent slats 8, thereby ensuring an airtightness of the back door 7. In addition, the back door 7 includes the reinforcements 9 and the second joint portions 16. Each reinforcement 9 reinforces two of the slats 8 that are adjacent to each other, and is disposed to extend in the direction perpendicular to the extending direction of the pair of elevating guide rails 20. Each second joint portion 16 joints the two adjacent slats 8 to the reinforcement 9. The reinforcement 9 is configured to cover the second joint portions 16, thereby preventing access into the vehicle even in the event that the first joint portion 15 is cut from the outside of the vehicle 1.

In the present embodiment, the reinforcement 9 and the second joint portions 16 are disposed inward of the slats 8 inside the vehicle 1, providing a good external appearance with the back door 7.

In the present embodiment, the second joint portions 16 are made of the same flexible material as that of the first joint portion 15, and integrally formed with the first joint portion 15. With this configuration, the joining between two adjacent slats 8 and the joining between the two adjacent slats 8 and the reinforcement 9 may be performed at the same time, which facilitates assembling of the back door 7.

In the present embodiment, the second joint portions 16 define the void 17 extending through the flexible material. This configuration facilitates the elastic deformation of the first joint portions 15 at the curved portion 20a of the elevating guide rail 20, so that adjacent slats 8 in the vicinity of the curved portion 20a are easily bent at the first joint portions 15. Accordingly, the back door 7 slides smoothly along the elevating guide rails 20.

In the present embodiment, the reinforcement 9 has two protrusions 18 protruding toward the slats 8 in such a manner as to conceal the second joint portions 16. With this configuration, the second joint portions 16 are hidden by the protrusions 18 and not visible, providing a good external appearance with the back door 7.

The present disclosure is not limited to the embodiment described above. For example, in the above embodiment, the first joint portion 15 and the second joint portions 16 are integrally formed. However, the first joint portion 15 and the second joint portions 16 may be formed as separate parts. In this case, the flexible material forming the first joint portion 15 may be different from that forming the second joint portions 16.

In the above embodiment, the second joint portions 16 define the void 17 extending through the flexible material. However, such a void 17 may not be necessarily.

In the above embodiment, the reinforcement 9 and the second joint portions 16 are disposed inward of the slats 8 inside the vehicle 1. However, the reinforcement 9 and the second joint portions 16 may be disposed outward of the slats 8 outside the vehicle 1. In this case, the side seal 23 is disposed inside the vehicle 1.

In the above embodiment, each elevating guide rail 20 has the curved portion 20a curved along the curved portion 4a of the side panel 4. However, such a curved portion 20a may not be disposed in the elevating guide rail 20.

In the above embodiment, when the back door 7 is open, the back door 7 moves toward the front side of the vehicle body 2 by passing outside the roof panel 3 (outside the vehicle 1) along the roof guide rails 24. However, the back door 7 may move toward the front side of the vehicle body 2 by passing between the roof panel 3 and an interior part (not illustrated) of the vehicle body 2.

In the above embodiment, the slats 8 are made of transparent resin. However, the resin forming the slats 8 is not limited to the transparent resin.

In the above embodiment, the back door 7 is operated manually to open and close with the door pull 11, which is disposed at the undermost slat 8 in the vertical direction of the vehicle body 2 to perform the opening and closing operation of the back door 7. However, the back door 7 may be operated electrically to open and close.

In the above embodiment, the back door 7 is configured to move elevatably relative to the opening 2a disposed at rear end part of the vehicle body 2. However, the present disclosure is applicable not only to the back door 7 but also to side doors. The present disclosure is also applicable to other opening and closing structures in a vehicle other than the doors. In addition, the present disclosure is not limited to the opening and closing structure to slide in the vertical direction of the vehicle, and is also applicable to an opening and closing structure that is slidable in the longitudinal direction or in the width direction of a vehicle if a pair of guide rails is disposed to face each other across an opening formed in the vehicle.

What is claimed is:

1. An opening and closing structure for a vehicle comprising:
a pair of guide rails disposed to extend facing each other across an opening formed in the vehicle; and
an opening and closing unit slidably guided along the pair of guide rails and configured to open and close the opening, wherein
the opening and closing unit includes:
a plurality of slats made of resin and arranged side by side in an extending direction of the guide rails;
a reinforcement reinforcing two of the slats that are adjacent to each other, the reinforcement disposed to extend in a direction perpendicular to the extending direction of the pair of guide rails;
a first joint portion made of a flexible material which is more flexible than the resin forming the slats, the first joint portion joining the two adjacent slats; and
second joint portions, each joining the two adjacent slats to the reinforcement, and
the reinforcement is configured to cover the second joint portions.

2. The opening and closing structure for the vehicle according to claim 1, wherein the reinforcement and the second joint portions are disposed inward of the slats inside the vehicle.

3. The opening and closing structure for the vehicle according to claim 1, wherein the second joint portions are made of the same flexible material as that of the first joint portion, and the second joint portions are integrally formed with the first joint portion.

4. The opening and closing structure for the vehicle according to claim 3, wherein the second joint portions define a void extending through the flexible material.

5. The opening and closing structure for the vehicle according to claim 1, wherein the reinforcement has a protrusion protruding toward the slats in such a manner as to conceal the second joint portions.
